(19) United States
(12) Patent Application Publication
(10) Pub. No.: US 2003/0116667 A1
(43) Pub. Date: Jun. 26, 2003

(54) Tape drive with a reel motor having a cooling function

(75) Inventors: Kazuya Tamura, Tokyo (JP); Eiichi Yoneyama, Tokyo (JP); James Zweighaft, Boulder, CO (US); Philip Turner, Boulder, CO (US)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co. Ltd, Tokyo (JP)

(21) Appl. No.: 10/032,373

(22) Filed: Dec. 21, 2001

(51) Int. Cl. G11B 15/32

(52) U.S. Cl. 242/349

(57) ABSTRACT

A reel motor (40) for rotatebly driving a take-up reel (30) rotatably attached onto an upper surface of a chassis (20) of a tape drive (10) comprises a motor board (41), a rotor (42) rotatably attached onto the motor board, and a stator (43) fixedly mounted to the motor board in close proximity to the outside of the rotor. The rotor has air flow means (423a, 423b) for flowing air in and out between the interior and the exterior of the tape drive. The air flow means may be at least one fin (423a) or at least one hole (423b).

### BACKGROUND OF THE INVENTION

This invention relates to a tape drive such as a linear tape storage system represented by DLT (Digital Linear Tape) or LTO (Linear Tape Open) and, in particular, to a cooling structure of a tape drive.

A tape drive of the type has been developed as a “backup” system for use in a hard disk of a computer system. A variety of linear storage systems have heretofore been proposed. For example, a digital linear tape drive serving as the DLT is disclosed in U.S. Pat. No. 5,862,014 to Nute, entitled “Multi-channel Magnetic Tape Head Module Including Flex Circuit”.

The digital linear tape drive (hereinafter may simply be called “driving apparatus”, “tape drive” or “drive”) is adapted to receive a tape cartridge (hereinafter may simply be called “cartridge”) having a single reel (supply reel). The digital linear tape drive includes a take-up reel in the interior thereof. When the tape cartridge is received in the driving apparatus, a magnetic tape is pulled out from the tape cartridge to be taken up around the take-up reel through a head guide assembly (HGA). The head guide assembly serves to guide, to a magnetic head, the magnetic tape (hereinafter may simply be called “tape”) pulled out from the tape cartridge. The magnetic head exchanges information between the tape and the magnetic head. Typically, the head guide assembly comprises an aluminum plate having a boomerang-like shape and six large guide rollers, each comprising a bearing.

The head guide assembly is also called a tape guide assembly which is disclosed, for example, in U.S. Pat. No. 5,414,585 to Saliba, entitled “Rotating Tape Edge Guide”. An example of the guide roller is disclosed in Japanese Unexamined Patent Publication No. 2000-100025.

As disclosed in U.S. Pat. No. 5,793,574 to Cranson et al., entitled “Tape Head Actuator Assembly Having A Shock Suppression Sleeve” for example, a tape drive typically comprises a substantially rectangular housing having a common base. The base has two spindle motors (reel motors). The first spindle motor has a spool (take-up reel) permanently mounted to the base. The spool is dimensioned to accept a magnetic tape streaming at a relatively high speed. The second spindle motor (reel motor) is adapted to receive a removable tape cartridge. The removable tape cartridge is manually or automatically inserted into the drive via a slot formed on the housing of the drive. When the tape cartridge is inserted into the slot, the cartridge is engaged with the second spindle motor (reel motor). Prior to rotation of the first and the second spindle motors (reel motors), the tape cartridge is connected to the permanently mounted spool (take-up reel) by means of a mechanical buckling mechanism. A number of rollers (guide rollers) positioned between the tape cartridge and the permanent spool guide the magnetic tape as it streams at a relatively high speed back and forth between the tape cartridge and the permanently mounted spool.

The digital linear tape drive of the above-mentioned structure requires a device for pulling the tape from the supply tape reel to the take-up reel. Such pulling device is disclosed, for example, in International Publication No. WO86/07471. According to WO86/07471, the take-up reel is provided with take-up leader means (first tape leader) coupled thereto. To the tape on the supply reel, supply tape leader means (second tape leader) is fixed. The first tape leader has a mushroom-shaped tab formed at its one end. The second tape leader has a locking hole. The tab is engaged with the locking hole.

Furthermore, a mechanism for joining the first tape leader to the second tape leader is required. Such joining mechanism is disclosed, for example, in International Publication No. WO86/07295.

Japanese Unexamined Patent Publication No. 2000-100116 discloses a structure of a leader tape engaging part capable of locking an end of a leader tape (second tape leader) to a tape end hooking part of the tape cartridge without requiring a tab protruding on a lateral side of the leader tape.

U.S. Pat. No. 5,857,634 to Hertrich, entitled “Take-up Reel Lock” discloses a lock system for preventing the rotation of the take-up reel of the tape drive when the tape cartridge is not inserted into the drive.

The tape drive further comprises a tape head actuator assembly. The tape head actuator assembly is positioned between the take-up spool and the tape cartridge along a tape path defined by a plurality of rollers. In operation, the magnetic tape streams back and forth between the take-up spool and the tape cartridge, coming into close proximity to the head actuator assembly while streaming along the defined tape path. An example of the head actuator assembly of the type is disclosed in U.S. Pat. No. 5,793,574 mentioned above.

On the other hand, Japanese Unexamined Patent Publication No. 2000-149491 discloses an example of the tape cartridge to be received in the digital linear tape drive.

Moreover, U.S. Pat. No. 6,241,171 to Gaboury, entitled “Leaderless Tape Drive” discloses a tape drive in which a tape leader is pushed and moved from a tape cartridge to a take-up reel without using a buckling mechanism or a take-up leader.

As described above, the tape drive comprises the first and the second reel motors which are mounted on a chassis. Each of the first and the second reel motors typically comprises an inner-rotor motor.

Specifically, the first reel motor comprises a motor board made of a magnetic material, a rotor rotatably attached onto the motor board, and a stator fixedly mounted on the motor board. The first reel motor is an inner-rotor motor in which the rotor is disposed inside the stator. The first reel motor has a cylindrical rotation supporting member fixed to the motor board and vertically standing up from an approximate center thereof. The rotor is rotatably supported on the cylindrical rotation supporting member through a ball bearing. Specifically, the rotor comprises a rotary shaft, a dish-like rotary member, and a ring-shaped magnet. The rotary shaft is attached to the cylindrical rotation supporting member through the ball bearing. The dish-like rotary member extends from a lower end of the rotary shaft in a direction perpendicular to an extending direction of the rotary shaft and has an outer peripheral end portion perpendicularly bent upward. The ring-shaped magnet is fixedly attached to an outer peripheral surface of the outer peripheral end portion of the dish-like rotary member.

On the other hand, the stator is disposed on the motor board in close proximity to an outer peripheral side of the ring-shaped magnet. The stator comprises a plurality of stator cores radially extending and stator coils wound around the stator cores, respectively.

To the back surface of the chassis in an area where the first reel motor is mounted, attached is a circuit board for mounting a large number of circuit components such as an integrated circuit (IC) for driving the above-mentioned tape drive. In this event, the circuit board covers the back surface of the chassis except the portion of the motor of the first reel motor.

As described above, the back surface of the chassis is covered with the circuit board for mounting the IC. Therefore, heat generated at the IC is transmitted through the circuit board to the interior of the tape drive so that the internal space of the tape drive is put into a high-temperature condition. Consequently, there is a problem of thermal distortion occurring in a driving portion disposed in the interior of the tape drive. Further, the magnetic tape (medium) running in the interior of the tape drive has a heat-resistant temperature of only 49° C. Therefore, when the temperature of the internal space of the tape drive exceeds 49° C., the magnetic tape becomes useless.

In order to solve the above-mentioned problem that the temperature of the internal space of the tape drive inevitably becomes high, use has heretofore been made of two cooling measures as described below. The first cooling measure is a method in which a heat-radiation plate (sheet) is attached to the IC acting as a heat source. The second cooling measure is a method in which a fan motor is attached on the side of a set (computer main body) to which the above-mentioned tape drive is mounted.

However, the first cooling measure in which the heat-radiation plate is attached to the IC is originally intended to suppress heat generation of the IC itself, not to cool the tape drive itself. Further, the second cooling measure in which the fan motor is attached on the side of the set is primarily intended to cool the computer main body itself, not to exclusively cool the tape drive itself. Therefore, either of the first and the second cooling measures is not so effective in cooling the internal space of the tape drive. In other words, although a cooling effect is achieved to a certain extent, either of the first and the second measures is originally intended not to cool the tape drive itself but merely to indirectly cool the internal space of the tape drive. As a consequence, there arises a demand for a method of directly cooling the internal space of the tape drive.

### SUMMARY OF THE INVENTION

It is therefore an object of the present invention to provide a tape drive capable of directly and efficiently cooling an internal space of the tape drive.

Other objects of the present invention will become clear as the description proceeds.

Stating the gist of the first aspect of the present invention, it will be understood that a tape drive serves to perform information exchange between it and a magnetic tape. The tape drive comprises a chassis having an upper surface and a lower surface. A take-up reel is rotatably attached onto the upper surface of the chassis. A reel motor attached to the lower surface of the chassis serves to drive and rotate the take-up reel. The reel motor comprises a motor board, a rotor rotatably attached onto the motor board, and a stator fixedly mounted to the motor board in close proximity to the outside of the rotor. A circuit board covers the lower surface of the chassis except the rotor of the reel motor. According to the first aspect of the present invention, the rotor has air flow means for flowing air in and out between the interior and the exterior of the tape drive.

Stating the gist of the second aspect of the present invention, it will be understood that a reel motor serves to drive and rotate a reel. The reel motor comprises a motor board, a rotor rotatably attached onto the motor board, and a stator fixedly mounted to the motor board in close proximity to the outside of the rotor. According to the second aspect of the present invention, the rotor has air flow means for flowing air in and out between the inside and the outside of the rotor.

In the above-mentioned tape drive and the above-mentioned reel motor, the air flow means may be at least one fin or at least one hole.

### BRIEF DESCRIPTION OF THE DRAWING

FIG. 1 is a perspective view of a tape drive according to one embodiment of the present invention in a state where an upper cover is removed;

FIG. 2 is a perspective view of the tape drive illustrated in FIG. 1 as seen from a back surface side;

FIG. 3 is a sectional view of the tape drive illustrated in FIG. 1;

FIG. 4 is a perspective view of an example of a reel motor for use in the tape drive illustrated in FIG. 1; and

FIG. 5 is a perspective view of another example of the reel motor for use in the tape drive illustrated in FIG. 1.

### DESCRIPTION OF THE PREFERRED EMBODIMENT

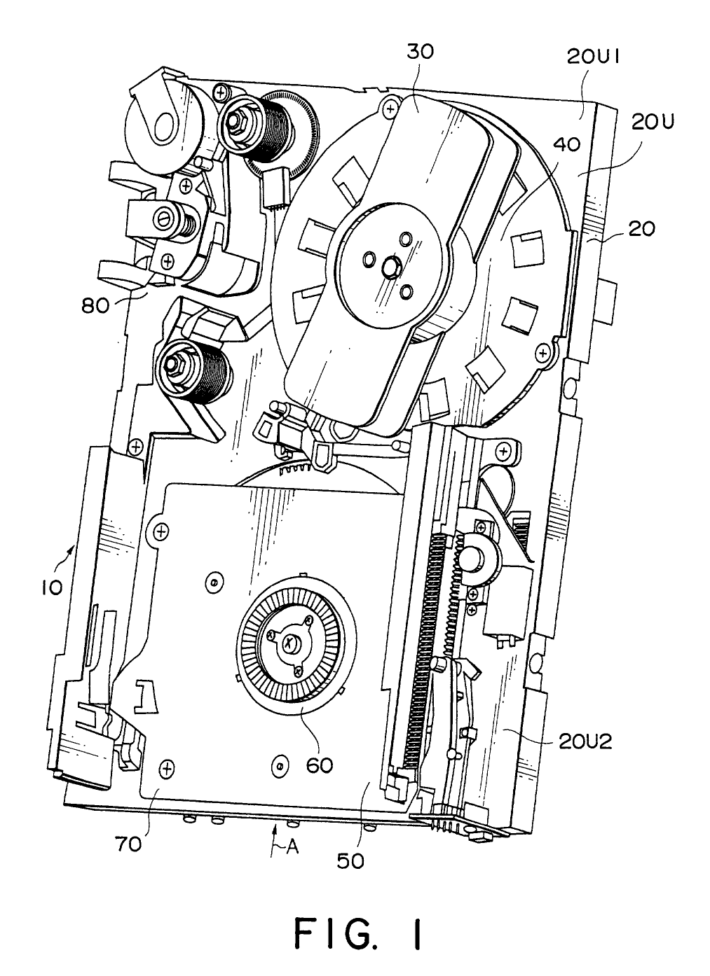

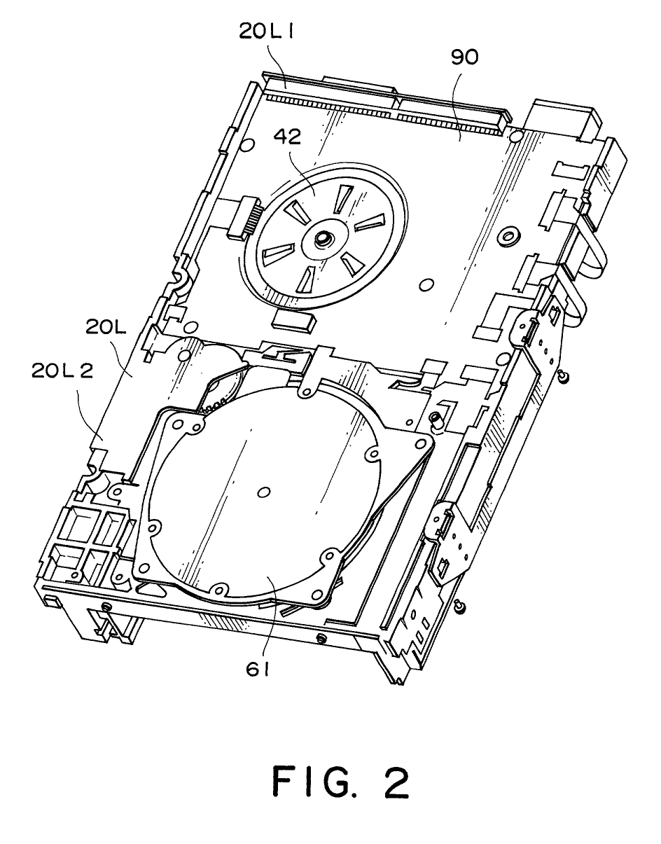

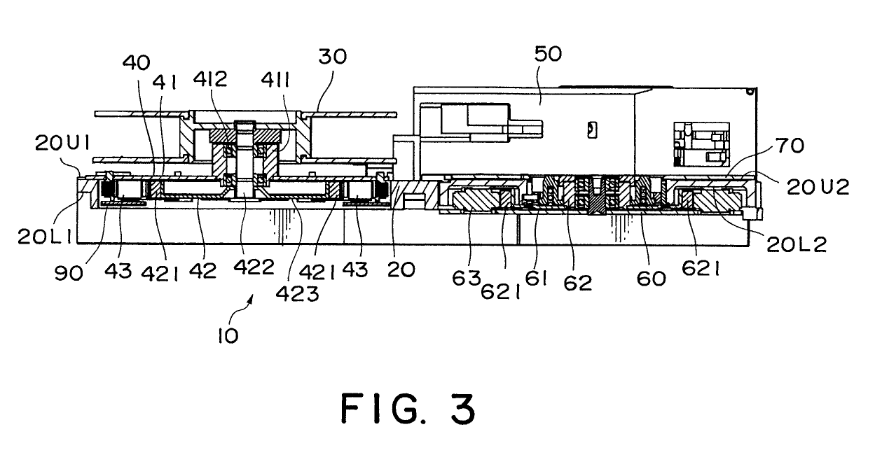

Referring to FIGS. 1, 2 and 3, description will be made about a tape drive according to one embodiment of the present invention. FIG. 1 is a perspective view of the tape drive 10, showing a state where an upper cover is removed. FIG. 2 is a perspective view of the tape drive 10 in FIG. 1 as seen from a back surface side. FIG. 3 is a sectional view of the tape drive 10 in FIG. 1.

The tape drive 10 comprises a chassis 20 having an upper surface 20U and a lower surface 20L. The upper surface 20U is divided into a first upper region 20U1 and a second upper region 20U2. Similarly, the lower surface 20L is divided into a first lower region 20L1 and a second lower region 20L2 facing the first upper region 20U1 and the second upper region 20U2, respectively.

The tape drive 10 further comprises a take-up reel 30, a first reel motor 40, a slot portion 50, and a second reel motor 60. The first reel motor 40 may be called a take-up reel motor, and the second reel motor 60 may be called a supply reel motor.

The take-up reel 30 is rotatably attached onto the first upper region 20U1 of the chassis 20. The first reel motor (take-up reel motor) 40 is attached to the first lower region 20L2 and serves as a motor for driving and rotating the take-up reel 30. As shown in FIG. 3, the first reel motor 40 comprises a first motor board 41 made of a magnetic material, a first rotor 42 rotatably attached onto the first motor board 41, and a first stator 43 fixedly mounted to the first motor board 41. The first reel motor 40 is an inner-rotor motor in which the first rotor 42 is disposed inside the first stator 43. The first rotor 42 comprises a first ring-shaped magnet 421. As will later be described in detail, the first rotor 42 is provided with air flow means for flowing air in and out between the interior and the exterior of the tape drive 10.

On the other hand, the slot portion 50 is formed on the second upper region 20U2 of the chassis 20. To the slot portion 50, a tape cartridge (not shown) is inserted along an insertion direction depicted by an arrow A in FIG. 1. The tape cartridge comprises a rotatable supply reel and a magnetic tape wound around the supply reel. The second reel motor (supply reel motor) 60 is attached to the second lower region 20L2 of the chassis 20 and serves as a motor for rotatably driving the supply reel when the tape cartridge is inserted into the slot portion 50. The second reel motor 60 comprises a second motor board 61 made of a magnetic material, a second rotor 62 rotatably attached onto the second motor board 61, and a second stator 63 fixedly mounted on the second motor board 61. Like the first reel motor 40, the second reel motor 60 is an inner-rotor motor in which the second rotor 62 is disposed inside the second stator 63. The second rotor 62 has a second ring-shaped magnet 621.

As apparent from FIG. 3, the first reel motor (take-up reel motor) 40 is arranged in a reversed position with respect to the second reel motor (supply reel motor) 60. In other words, in the first reel motor 40, the first rotor 42 and the first stator 43 are arranged on the lower surface of the first motor board 41. In the second reel motor 60, the second rotor 62 and the second stator 63 are arranged on the upper surface of the second motor board 61. Thus, in the second reel motor 60, the second ring-shaped magnet 621 of the second rotor 62 is exposed on the outside. Inasmuch as the second ring-shaped magnet 621 has strong magnetism, the second reel motor 60 is covered with a plate 70 made of an iron-based magnetic material in order to shield magnetic leakage.

According to the tape drive 10 of the above-mentioned structure, it is possible to carry out information exchange between a magnetic head 80 and a magnetic tape (not shown) pulled out from the supply reel and wound around the take-up reel 30.

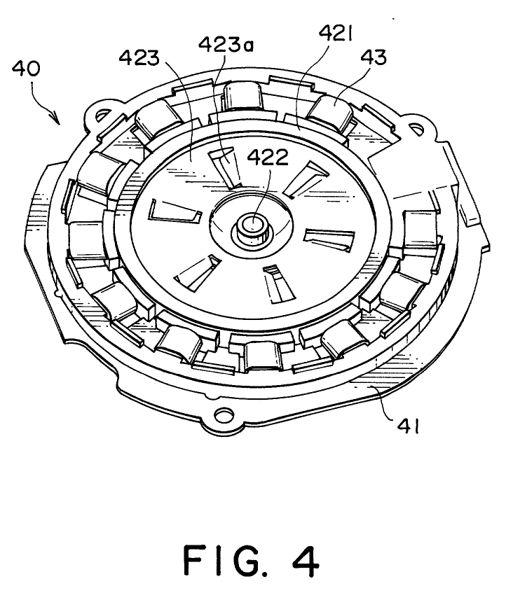

Referring to FIG. 4 in addition to FIG. 3, description will be made more in detail about the structure of the first reel motor 40.

The first reel motor 40 comprises a cylindrical rotation supporting member 411 fixed on the first motor board 41 and vertically standing up from an approximate center thereof. The rotor 42 is rotatably supported on the cylindrical rotation supporting member 411 through a ball bearing 412. Specifically, the first rotor 42 comprises a rotary shaft 422, a dish-like rotary member 423, and a first ring-shaped magnet 421. The rotary shaft 422 is rotatably attached to the cylindrical rotation supporting member 411 through the ball bearing 412. The dish-like rotary member 423 extends from a lower end of the rotary shaft 422 in a direction perpendicular to an extending direction of the rotary shaft 422 and has an outer peripheral end portion perpendicularly bent upward. The first ring-shaped magnet 421 is fixedly attached to an outer peripheral surface of the outer peripheral end portion of the dish-like rotary member 423.

On the other hand, the first stator 43 is disposed on the first motor board 41 in close proximity to an outer peripheral side of the first ring-shaped magnet 421. As shown in FIG. 4, the first stator 43 comprises a plurality of stator cores radially extending and stator coils wound around the stator cores, respectively.

As shown in FIG. 2, to the back surface (first lower region) 20L1 of the chassis 20 in an area where the first reel motor 40 is mounted, attached is a circuit board 90 for mounting a large number of circuit components (not shown) such as an integrated circuit (IC) for driving the above-mentioned tape drive 10.

As described above, the back surface 20L1 of the chassis 20 is covered with the circuit board 90 for mounting the IC. Therefore, heat generated at the IC is transmitted through the circuit board 90 to the interior of the tape drive 10 so that the internal space of the tape drive 10 may be put into a high-temperature condition.

In the present invention, in order to cool the internal space of the tape drive 10, the dish-like rotary member 423 of the first rotor 42 is provided with at least one (six in the example being illustrated in FIG. 4) fin 423a, as shown in FIG. 4. With this structure, rotation of the first rotor 42 of the first reel motor 40 causes an air stream to occur, making it possible to directly cool the internal space of the tape drive 10. In other words, the fin 423a serves as air flow means for flowing air in and out between the interior and the exterior of the tape drive 10.

Consequently, inasmuch as the internal space of the tape drive 10 can be cooled, it is possible to prevent occurrence of thermal distortion in a driving portion disposed in the interior of the tape drive 10. In addition, inasmuch as the internal space of the tape dive 10 can be cooled to be continuously kept at a temperature not higher than 49° C., it is possible to suppress deterioration in quality of a magnetic tape (medium) running in the interior of the tape drive 10.

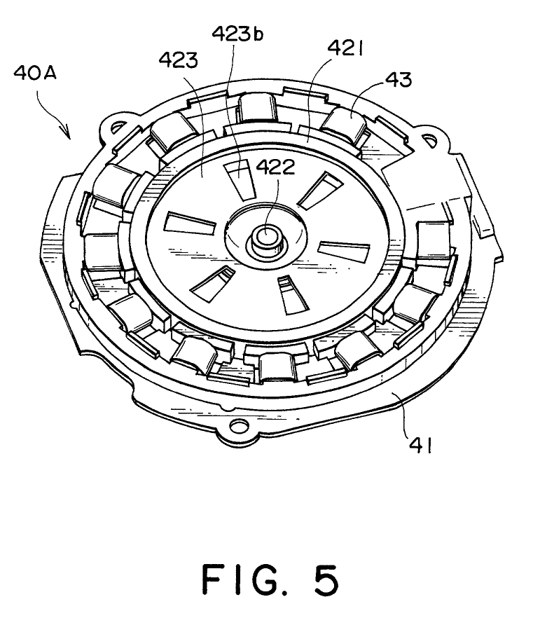

Referring to FIG. 5, a first reel motor 40A is similar in structure to the first reel motor 40 shown in FIG. 4, except that holes 423b, instead of the fin 423a, are provided as air flow means.

It is apparent that this structure also exhibits functions and effects similar to those of the reel motor shown in FIG. 4.

As thus far been described in conjunction with the preferred embodiment of the present invention, it will readily be understood that a variety of modifications can be made by those skilled in the art within a scope which does not deviate from the spirit of the present invention. For example, in the foregoing embodiments, the rotor is provided with the fin or the hole as air flow means. However, the air flow means is not limited to these configurations but may have various other configurations such as a step, a groove, and a vane.

What is claimed is:

1. A tape drive (10) for performing information exchange between said tape drive and a magnetic tape, said tape drive comprising:
a chassis (20) having an upper surface (20U) and a lower surface (20L);
a take-up reel (30) rotatably attached onto the upper surface of said chassis;
a reel motor (40) attached to the lower surface of said chassis and serving to rotatably drive said take-up reel, said reel motor comprising a motor board (41), a rotor (42) rotatably attached onto said motor board , and a stator (43) fixedly mounted to said motor board in close proximity to the outside of said rotor, said rotor having air flow means (423a, 423b) for flowing air in and out between the interior and the exterior of said tape drive; and
a circuit board (90) covering the lower surface of said chassis.

2. A tape drive as claimed in claim 1, wherein said air flow means is at least one fin (423a).

3. A tape drive as claimed in claim 1, wherein said air flow means is at least one hole (423b).

4. A reel motor (40) for rotatably driving a reel (30), said reel motor comprising:
a motor board (41);
a rotor (42) rotatably attached onto said motor board; and
a stator (43) fixedly mounted to said motor board in close proximity to the outside of said rotor, wherein
said rotor having air flow means (423a, 423b) for flowing air in and out between the inside and the outside of said rotor.

5. A reel motor as claimed in claim 4, wherein said air flow means is at least one fin (423a).

6. A reel motor as claimed in claim 1, wherein said air flow means is at least one hole (423b).
